(19) United States
(12) Patent Application Publication
(10) Pub. No.: US 2026/0361029 A1
(43) Pub. Date: Nov. 12, 2026

(54) Connector Assembly

(71) Applicant: Aptiv Technologies AG, Schaffhausen (CH)

(72) Inventors: Dale Smutny, Canfield, OH (US); Siddhan Manickam, Salem (IN); Surendhar Ns, Coimbatore (IN); Dineshkumar Manoharan, Chennai (IN)

(21) Appl. No.: 19/316,322

(22) Filed: Sep. 2, 2025

Related U.S. Application Data
(60) Provisional application No. 63/802,160, filed on May 8, 2025.

(51) Int. Cl. H01R 13/627; H01R 13/504; H01R 13/52; H01R 13/629

(52) U.S. Cl. CPC H01R 13/6273; H01R 13/504; H01R 13/521; H01R 13/629; H01R 2201/26

(57) ABSTRACT

A connector elbow for a connector assembly includes a base and an extension. The extension extends from the base. The base and the extension collectively define a first cavity. The extension defines a collar disposed around at least a portion of the first cavity. The collar is configured to engage a tab of a housing and a lock member to restrict translation of the connector elbow within a second cavity of the housing. The first cavity is configured to receive a terminal.

### CROSS-REFERENCE TO RELATED APPLICATIONS

This application claims the benefit of U.S. Provisional Application No. 63/802,160 filed May 8, 2025, the entire disclosure of which is incorporated by reference.

### FIELD

The present disclosure relates to a connector assembly and more particularly to a connector assembly that may be used with a vehicle.

### BACKGROUND

Modern vehicles rely on electrical cables and connections to facilitate communication between various electronic components. The integrity of these connections is essential to the overall reliability and performance of the vehicle. Coaxial (COAX) connectors play a key role in maintaining this integrity. For example, space around electronic control units, antennas, and/or communication modules is often limited, with components frequently mounted in tight or irregularly shaped compartments. A COAX connector with an elbow portion can enable flexible cable routing without excessive bending or strain on the cable. While known COAX connectors have proven acceptable for their intended purpose, a continuous need for improvement remains in the pertinent art.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to aspects of the disclosure, a connector elbow for a connector assembly is provided. The connector assembly includes a base and an extension. The extension extends from the base. The base and the extension collectively define a first cavity. The extension defines a collar disposed around at least a portion of the first cavity. The collar is configured to engage a tab of a housing and a lock member to restrict translation of the connector elbow within a second cavity of the housing. The first cavity is configured to receive a terminal.

According to other aspects of the disclosure, a housing for a connector assembly is provided. The housing includes a body. The body defines a cavity, a tab, and a slot. The cavity is configured to rotatably receive a connector elbow. The tab is configured to engage the connector elbow and the slot is configured to receive a lock member to restrict translation of the connector elbow within the cavity.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is an exploded view of an example connector assembly in accordance with the principles of the present disclosure.

FIG. 2 a perspective view of the connector assembly of FIG. 1 in an assembled configuration.

FIG. 3 is a front perspective view of the connector assembly of FIG. 1 in a rotated configuration.

FIG. 4 is a cross-sectional view of the connector assembly of FIG. 2 taken along the line 4 -4 of FIG. 2.

FIG. 5 is a perspective view of an example housing of a connector assembly in accordance with the principles of the present disclosure.

FIG. 6 is a cross-sectional view of the connector assembly of FIG. 2 taken along the line 6 -6 of FIG. 2.

FIG. 7 is a cross-sectional view of the connector assembly of FIG. 2 taken along the line 7 -7 of FIG. 2.

In the drawings, reference numbers may be reused to identify similar and/or identical elements.

### DETAILED DESCRIPTION

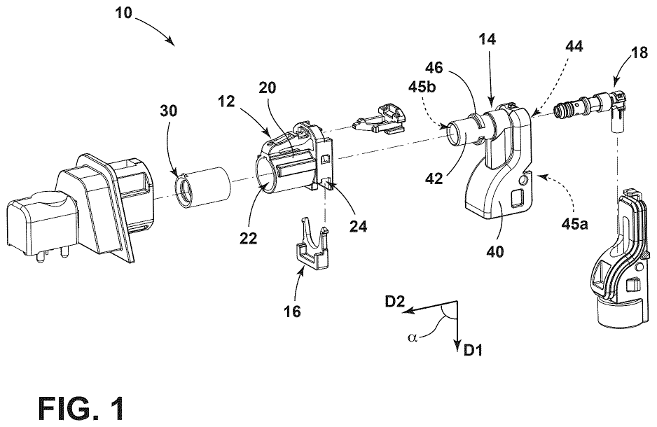

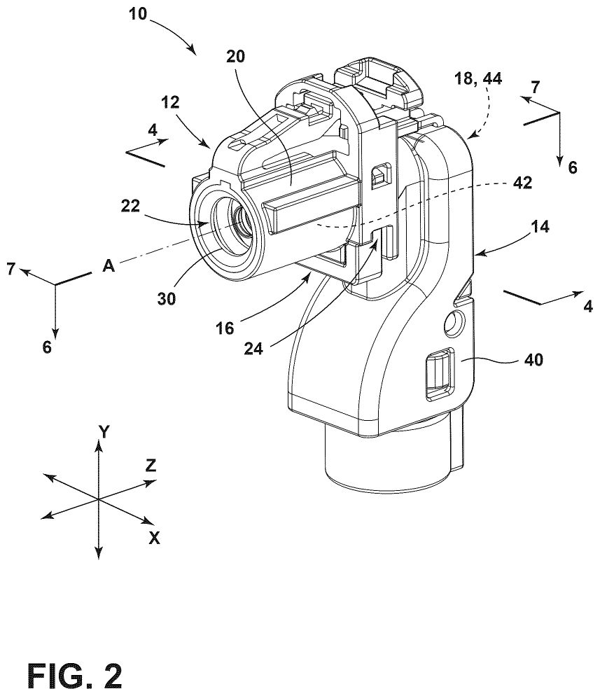

With reference to FIGS. 1 and 2, an example connector assembly 10 (e.g., a coaxial connector assembly) is shown. As will be explained in more detail below, the connector assembly 10 may be installed in a vehicle (e.g., an automobile) to facilitate the transmission of electrical signals and/or electricity between various electronic components within the vehicle. In various implementations, the connector assembly 10 includes a housing 12, a connector elbow 14, a lock member 16, and a terminal assembly 18, among others.

Referring now to FIGS. 1, 2, and 5, the housing 12 (e.g., an outer connector) may comprise one or more of a variety of shapes, sizes, configurations, and/or materials. The housing 12 may connect with the connector elbow 14, the lock member 16, and/or the terminal assembly 18, among others. The housing 12 may include a body 20 that defines a central axis A, a cavity 22 surrounding the central axis A, and a slot 24. The cavity 22 may receive portions of the connector elbow 14 and/or the terminal assembly 18, among others. The slot 24 may receive the lock member 16.

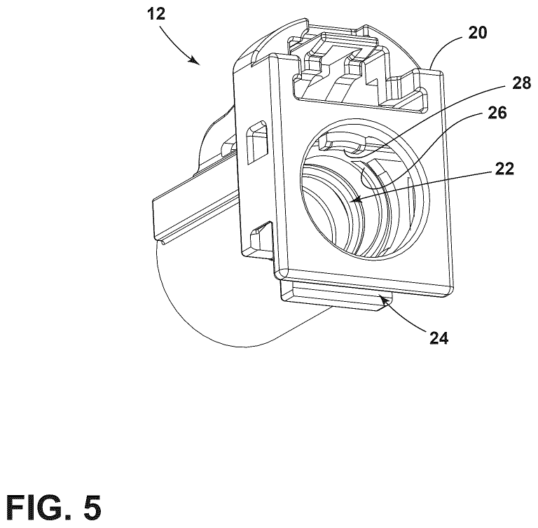

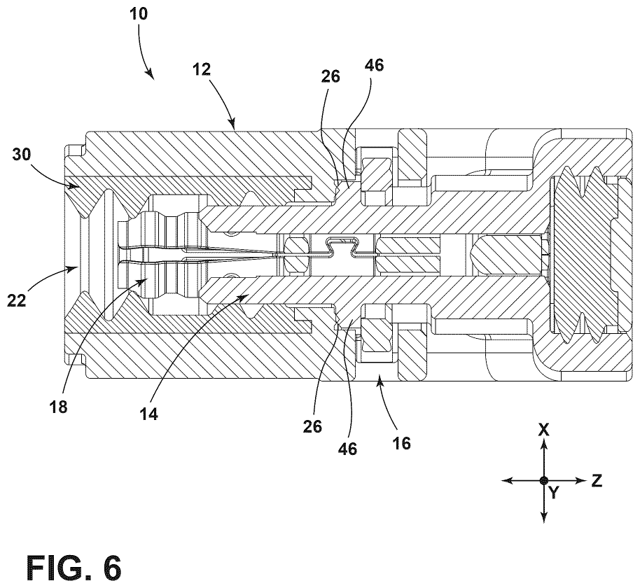

In various implementations, the housing 12 includes a rib 26 (see, e.g., FIG. 5). The rib 26 may extend from the body 20. The rib 26 may be disposed within the cavity 22. The rib 26 may engage the connector elbow 14 in the assembled configuration (see, e.g., FIG. 6). The rib 26 may be made of a material (e.g., a thermoplastic, etc.) that allows the elbow 14 to be welded (e.g., sonic welded) to the housing 12. The elbow 14 may be rotated relative to the housing 12 to a user-specified position (e.g., anywhere from 0 to 360 degrees), after which the rib 26 may be welded to the housing 12 to fix the elbow 14 in the selected position.

In various implementations, the housing 12 may include a tab 28 (see, e.g., FIG. 5). For example, the tab 28 may extend from the body 20 and be disposed in the cavity 22. As will be explained in more detail below, in an assembled configuration, the tab 28 may engage at least a portion of the connector elbow 14 to restrict and/or inhibit disengagement of the connector elbow 14 from the housing 12.

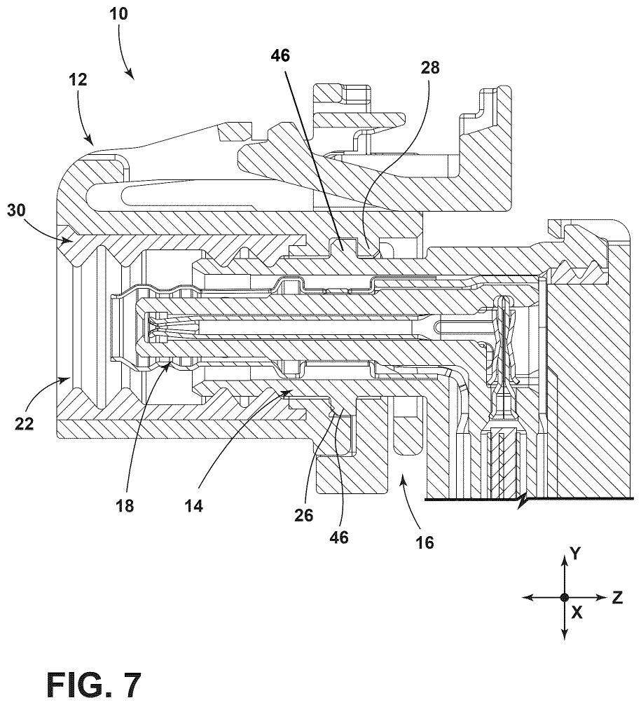

In various implementations, the housing 12 includes a seal 30. The seal 30 may be disposed in the cavity 22 and may surround the axis A. The seal 30 may be co-molded with the housing 12. In an assembled configuration, the seal 30 may engage the connector elbow 14 and/or the terminal assembly 18 (see, e.g., FIGS. 6 and 7) to restrict and/or inhibit a flow of water through the cavity 22.

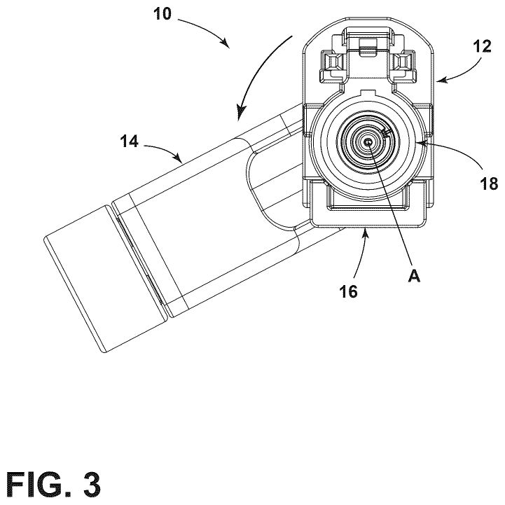

With reference to FIGS. 1 and 2, the connector elbow 14 may comprise one or more of a variety of shapes, sizes, configurations, and/or materials. In an assembled configuration, the connector elbow 14 may be rotatably coupled to the housing 12. For example, the connector elbow 14 may be disposed within the cavity 22 and operable to rotate relative to the axis A (see, e.g., FIG. 3). The connector elbow 14 may move (e.g., translate) within the cavity 22 (e.g., in the Z-direction).

In various implementations, the connector elbow 14 includes a base 40 and an extension 42 extending from the base 40. The base 40 may extend in a first direction D1 and the extension 42 may extend in a second direction D2 that is different than the first direction D1. The first direction D1 and the second direction D2 define an angle α. The angle α may be greater than zero degrees and less than 180 degrees. In some example configurations, the angle α is approximately (e.g., within ±10 degrees) 90 degrees.

In various implementations, the base 40 and the extension 42 may collectively define a cavity 44 that receives the terminal assembly 18. A first portion 45a of the cavity 44 may extend in the first direction D1 and a second portion 45b of the cavity 44 may extend in the second direction D2. In an assembled configuration, the extension 42 may be disposed in the cavity 22 of the housing 12 and may engage the seal 30 (see, e.g., FIGS. 6 and 7).

Referring now to FIG. 1, the extension 42 may include an annular collar 46 extending around at least a portion of the extension 42 and, in the assembled configuration, the axis A. In various implementations, features of the housing 12 (e.g., tab 28) and the connector elbow 14 (e.g., collar 46) are arranged such that the housing 12 receives the connector elbow 14 at a predetermined angle or orientation.

As will be explained in more detail below, upon assembly of the connector elbow 14 and the housing 12, the tab 28 may engage the collar 46 to prevent translation of the connector elbow 14 relative to the housing 12 along (e.g., in the Z-direction) the axis A, while allowing rotation of the connector elbow 14 relative to the housing 12 around (e.g., between 0 degrees and 360 degrees) the axis A. This engagement may serve as a primary lock for the connector elbow 14.

As will be explained in more detail below, upon assembly of the lock member 16 to the connector elbow 14 and the housing 12, the lock member 16 may engage the collar 46 to prevent translation of the connector elbow 14 relative to the housing 12 along (e.g., in the Z-direction) the axis A, while allowing rotation of the connector elbow 14 relative to the housing 12 around (e.g., between 0 degrees and 360 degrees) the axis A. This engagement may serve as a secondary lock for the connector elbow 14.

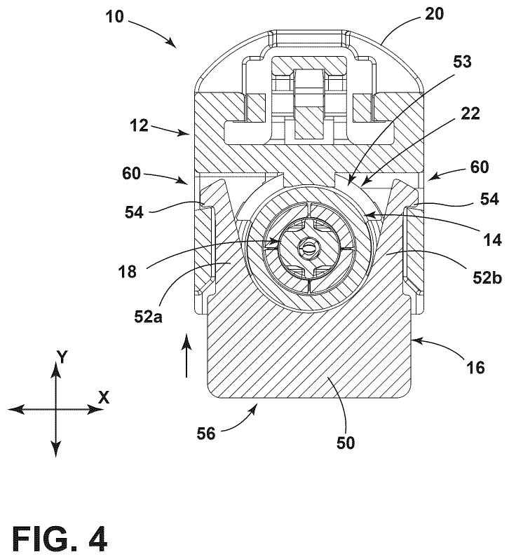

With reference to FIG. 4, the lock member 16 (e.g., an independent secondary lock (ISL)) may comprise one or more of a variety of shapes, sizes, configurations, and/or materials. The lock member 16 may include a body 50 and first and second arms 52a, 52b extending from the body 50. The first and second arms 52a, 52b may define a channel 53 configured to receive the connector elbow 14. Each of the first and second arms 52a, 52b may include a ramp portion 54. In the assembled configuration, the lock member 16 may be moveably (e.g., translatably) coupled to the housing 12. During assembly of the connector assembly 10, the lock member 16 may be moved (e.g., in the Y-direction) to a staged position 56 (e.g., a final position) within the slot 24 of the housing 12.

With continued reference to FIG. 4, the lock member 16 is shown in the staged position 56. In response to being in the staged position 56, each ramp portion 54 may be disposed in an aperture 60 of the housing 12 to secure the location of the lock member 16 relative to the housing 12. In various implementations, moving the lock member 16 to the staged position 56 includes moving the lock member 16 (e.g., in the Y-direction) so that the ramp portions 54 are moved into the apertures 60.

In various implementations, the lock member 16 engages the collar 46 when the ramp portions 54 are disposed in the apertures 60. In various implementations, the lock member 16 restricts translation of the connector elbow 14 within the cavity 22 (e.g., in the Z-direction) and permits the connector elbow 14 to rotate relative to the housing 12 when the ramp portions 54 are disposed in the apertures 60. In various implementations, the lock member 16 permits the connector elbow 14 to rotate 360 degrees relative to the housing 12 when the ramp portions 54 are disposed in the apertures 60.

With reference to FIG. 6, the connector assembly 10 is shown in an assembled configuration. In response to being in the assembled configuration, the lock member 16 engages the connector elbow 14 (e.g., the collar 46) to restrict the connector elbow 14 from translating in, e.g., the Z-direction, relative to, and disengaging from, the housing 12, while permitting the connector elbow 14 to rotate relative to the housing 12. For example, the lock member 16 restricts the connector elbow 14 from moving out of the cavity 22 (e.g., in the Z-direction).

With reference to FIG. 7, the connector assembly 10 is shown in an assembled configuration. In the assembled configuration, the tab 28 may engage the connector elbow 14 (e.g., the collar 46) to restrict the connector elbow 14 from translating in, e.g., the Z-direction, relative to, and disengaging from, the housing 12, while permitting the connector elbow 14 to rotate relative to the housing 12. For example, the tab 28 may restrict the connector elbow 14 from moving out of the cavity 22 (e.g., in the Z-direction).

The ability to rotate the connector elbow 14 relative to the housing 12 can facilitate easier installation and maintenance of the connector assembly 10 in confined spaces, improving assembly efficiency and reducing the risk of damage to the terminal assembly 18 or cable (not shown) connected thereto, or to the connector assembly 10, from vibration, misalignment, or mechanical stress commonly encountered in automotive environments, thereby preventing unintentional disengagement of the connector assembly 10 from another connector assembly (not shown).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

Spatial and functional relationships between elements (for example, between modules, circuit elements, semiconductor layers, etc.) are described using various terms, including “connected,” “engaged,” “coupled,” “adjacent,” “proximate,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “set” does not necessarily exclude the empty set—in other words, in some circumstances a “set” may have zero elements. The term “non-empty set” may be used to indicate exclusion of the empty set—in other words, a non-empty set will always have one or more elements. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

The examples of the present disclosure may include one or more components such as connectors, terminals, conductors, insulating members, shielding structures, housings, retention features, and sealing elements, among others, as well as corresponding systems and assemblies. These examples may be configured to facilitate electrical signal transmission, power delivery, electromagnetic compatibility, or mechanical retention under various environmental conditions, such as thermal cycling, vibration, or exposure to fluids. Disclosed components, systems and assemblies, among others, may be arranged modularly or integrally to accommodate various system architectures and routing constraints.

Disclosed components may be fabricated from thermoplastics, thermoset resins, composites, or metals, optionally treated or coated for corrosion resistance, electromagnetic interference shielding, or biocompatibility for use in various applications, system, and environments, among others. In particular, in medical applications, sterilizable and/or biocompatible materials may be used. In solar or renewable energy systems, UV-resistant and/or weatherproof materials may be incorporated. In aerospace and space-based systems, weight reduction may be prioritized, and high-performance materials such as polyimide films, fluoropolymers, or ceramic composites may be employed.

Disclosed components, systems and assemblies, among others, may be designed for automated assembly, including robotic insertion, ultrasonic welding, or crimping techniques. Adaptations may be made to ensure compliance with relevant standards, including International Organization for Standardization, Military Specification, Society of Automotive Engineers, Food and Drug Administration, or International Electrotechnical Commission, depending on the target industry or market. In this regard, while examples and embodiments of the present disclosure may be illustrated and described herein in the context of an automobile, it will be appreciated that such examples and embodiments are equally suited for other applications, systems, environments, industries, and markets, among others. For example, implementations of the present disclosure that relate generally to electrical components and assemblies, and more particularly to connectors, terminals, wiring harnesses, and integrated electrical interconnection systems, among others, are suitable for a wide range of environments and applications.

While exemplary embodiments described herein may reference automotive use cases, the disclosed technology is not limited thereto and may be employed in any system requiring, for example, robust, secure, reliable, and/or durable electrical connectivity, among others. In particular, the structures, materials, and configurations disclosed may be adapted for use in aerospace systems, medical devices, consumer electronics, industrial automation, energy distribution networks, solar and other renewable energy installations, marine vessels, and space exploration platforms. Accordingly, although specific embodiments may describe automotive implementations, the principles disclosed herein are equally applicable to any system requiring robust electrical interconnection, and claims directed to any system, application, and/or environmental domain are, and will be, contemplated by one of skill in the art.

Various example embodiments of the invention are described in the following clauses.

Clause 1: A connector elbow for a connector assembly, the connector elbow comprising: a base; and an extension extending from the base, the base and the extension collectively defining a first cavity, and the extension defining a collar disposed around at least a portion of the first cavity, the collar configured to engage a tab of a housing and a lock member to restrict translation of the connector elbow within a second cavity of the housing, the first cavity configured to receive a terminal.

Clause 2: The connector elbow of clause 1, wherein: the base extends in a first direction, and the extension extends in a second direction that is different than the first direction.

Clause 3: The connector elbow of clause 2, wherein the first direction and the second direction define an angle greater than zero degrees and less than one hundred and eighty degrees.

Clause 4: The connector elbow of clause 3, wherein a first portion of the first cavity extends in the first direction and a second portion of the first cavity extends in the second direction.

Clause 5: The connector elbow of any of clauses 1 through 4, wherein the collar is disposed around the extension.

Clause 6: A connector assembly comprising: the connector elbow of any of clauses 1 through 5; and a housing including a second cavity, a tab, and a slot, the second cavity configured to rotatably receive the connector elbow, and the tab configured to engage the collar and the slot configured to receive a lock member to restrict translation of the connector elbow within the second cavity.

Clause 7: The connector assembly of clause 6, further comprising a seal disposed in the second cavity and configured to surround the connector elbow.

Clause 8: The connector assembly of clause 6 or 7, wherein: the lock member includes a first arm and a second arm opposite the first arm, and the first and second arms define a channel configured to receive the connector elbow.

Clause 9: The connector assembly of clause 8, wherein the first and second arms are configured to engage the collar.

Clause 10: The connector assembly of any of clauses 6 through 9, wherein the lock member is configured to translate in a first direction within the slot.

Clause 11: The connector assembly of clause 10, wherein the connector elbow is configured to translate in a second direction within the second cavity.

Clause 12: The connector assembly of clause 11, wherein the first direction is transverse to the second direction.

Clause 13: The connector assembly of any of clauses 6 through 12, wherein the housing includes an aperture configured to receive a portion of the lock member to restrict translation of the lock member relative to the housing.

Clause 14: The connector assembly of clause 13, wherein the lock member is configured to engage the collar when the portion of the lock member is disposed in the aperture.

Clause 15: The connector assembly of clause 13, wherein the lock member is configured to (i) restrict translation of the connector elbow within the second cavity and (ii) permit the connector elbow to rotate relative to the housing when the portion of the lock member is disposed in the aperture.

Clause 16: The connector assembly of clause 13, wherein the lock member is configured to permit the connector elbow to rotate 360 degrees relative to the housing when the portion of the lock member is disposed in the aperture.

Clause 17: The connector assembly of any of clauses 6 through 16, wherein, in an assembled configuration, the connector elbow is configured to rotate relative to the housing.

Clause 18: The connector assembly of any of clauses 6 through 17, wherein, in an assembled configuration, the connector elbow is configured to rotate 360 degrees relative to the housing.

Clause 19: The connector assembly of any of clauses 6 through 18, wherein: the housing defines a central axis, and in an assembled configuration, the connector elbow is configured to rotate about the central axis.

Clause 20: A housing for a connector assembly, the housing comprising: a body defining a cavity, a tab, and a slot, the cavity configured to rotatably receive a connector elbow, and the tab configured to engage the connector elbow and the slot configured to receive a lock member to restrict translation of the connector elbow within the cavity.

1. A connector elbow for a connector assembly, the connector elbow comprising:
a base; and
an extension extending from the base, the base and the extension collectively defining a first cavity, and the extension defining a collar disposed around at least a portion of the first cavity, the collar configured to engage a tab of a housing and a lock member to restrict translation of the connector elbow within a second cavity of the housing, the first cavity configured to receive a terminal.

2. The connector elbow of claim 1 wherein:
the base extends in a first direction, and
the extension extends in a second direction that is different than the first direction.

3. The connector elbow of claim 2 wherein the first direction and the second direction define an angle greater than zero degrees and less than one hundred and eighty degrees.

4. The connector elbow of claim 3 wherein a first portion of the first cavity extends in the first direction and a second portion of the first cavity extends in the second direction.

5. The connector elbow of claim 1 wherein the collar is disposed around the extension.

6. A connector assembly comprising:
the connector elbow of claim 1; and
a housing including a second cavity, a tab, and a slot, the second cavity configured to rotatably receive the connector elbow, and the tab configured to engage the collar and the slot configured to receive a lock member to restrict translation of the connector elbow within the second cavity.

7. The connector assembly of claim 6 further comprising a seal disposed in the second cavity and configured to surround the connector elbow.

8. The connector assembly of claim 6 wherein:
the lock member includes a first arm and a second arm opposite the first arm, and
the first and second arms define a channel configured to receive the connector elbow.

9. The connector assembly of claim 8 wherein the first and second arms are configured to engage the collar.

10. The connector assembly of claim 6 wherein the lock member is configured to translate in a first direction within the slot.

11. The connector assembly of claim 10 wherein the connector elbow is configured to translate in a second direction within the second cavity.

12. The connector assembly of claim 11 wherein the first direction is transverse to the second direction.

13. The connector assembly of claim 6 wherein the housing includes an aperture configured to receive a portion of the lock member to restrict translation of the lock member relative to the housing.

14. The connector assembly of claim 13 wherein the lock member is configured to engage the collar when the portion of the lock member is disposed in the aperture.

15. The connector assembly of claim 13 wherein the lock member is configured to (i) restrict translation of the connector elbow within the second cavity and (ii) permit the connector elbow to rotate relative to the housing when the portion of the lock member is disposed in the aperture.

16. The connector assembly of claim 13 wherein the lock member is configured to permit the connector elbow to rotate 360 degrees relative to the housing when the portion of the lock member is disposed in the aperture.

17. The connector assembly of claim 6 wherein, in an assembled configuration, the connector elbow is configured to rotate relative to the housing.

18. The connector assembly of claim 6 wherein, in an assembled configuration, the connector elbow is configured to rotate 360 degrees relative to the housing.

19. The connector assembly of claim 6 wherein:
the housing defines a central axis, and
in an assembled configuration, the connector elbow is configured to rotate about the central axis.

20. A housing for a connector assembly, the housing comprising:
a body defining a cavity, a tab, and a slot, the cavity configured to rotatably receive a connector elbow, and the tab configured to engage the connector elbow and the slot configured to receive a lock member to restrict translation of the connector elbow within the cavity.
